(19) United States
(12) Patent Application Publication
(10) Pub. No.: US 2025/0168745 A1
(43) Pub. Date: May 22, 2025

(54) CONTROL OF A DATA TRANSMISSION BY PROVIDING A COMMUNICATION PAUSE

(71) Applicant: Siemens Mobility GmbH, München (DE)

(72) Inventor: Roland Porsch, Speichersdorf (DE)

(21) Appl. No.: 18/841,461

(22) PCT Filed: Feb. 23, 2023
(86) PCT No.: PCT/EP2023/054611

§ 371 Date: Aug. 26, 2024

(30) Foreign Application Priority Data
Feb. 25, 2022 (DE) 10 2022 201 979.2

(51) Int. Cl. H04W 48/02; H04W 28/08; H04W 48/18

(52) U.S. Cl. CPC H04W 48/02; H04W 28/08; H04W 48/18

(57) ABSTRACT

A method for controlling a data transmission between a communication subscriber of a first type and a plurality of communication subscribers of a second type. In the method, at least one load characteristic related to the data transmission is detected. Furthermore, a comparison value is determined on the basis of the at least one load characteristic. The comparison value is compared with a predefinable limit value. So long as the comparison value is greater than the limit value, the data transmission between the communication subscriber of the first type and at least one of the plurality of communication subscribers of the second type is restricted or interrupted.

The invention relates to a method for controlling a data transmission, a system for implementing the method, a computer program product and a computer-readable medium.

Various resources are required for a transmission of data. On a physical level, hardware resources such as, for example, computing power, storage space and/or a number of accessible communication channels are required. In addition, different software resources may be required for implementing the data transmission. Such software resources are usually services, such as services for the purpose of file transfer or the transmission of process data of a communication subscriber. These services enable data transmission by means of predetermined protocols at various levels of the OSI standard model. To date, the resources required for data transmission have been adapted in dependence upon a need for a data quantity and/or data type to be transmitted. This is usually done by booking additional resource capacities with a cloud provider. If there is a very high volume of data to be transmitted within a short period of time, this can lead to a high cost. On the other hand, the aforementioned manner of adapting the resource capacity leads to a heavy load, in particular in mobile radio networks. Under certain circumstances, this can lead to failures of the mobile network or bottlenecks in it. This in turn leads to a poor quality of data transmission and possibly to increased data traffic due to repeated requests for the same data to be transmitted.

It is the object of the invention to disclose an improved method for controlling a data transmission.

This object is achieved by a method having the features of claim 1.

Furthermore, the object of the invention is to disclose a system for implementing the method in accordance with the invention.

This object is achieved by a system having the features of the coordinate system claim.

Furthermore, the object of the invention is to disclose a computer program for implementing the method and a computer-readable medium.

These objects are achieved by a computer program in accordance with the coordinate computer program claim and by a computer-readable medium in accordance with the coordinate claim with regard to a computer-readable medium.

Advantageous developments can be found in the dependent subordinate claims in each case.

The method in accordance with the invention is a method for controlling a data transmission between a communication subscriber of the first type and a plurality of communication subscribers of the second type. In order to control the data transmission, at least one load parameter that is related to the data transmission is detected. A comparison value is determined on the basis of the at least one load parameter. Furthermore, this comparison value is compared with a predefinable limit value. As soon as the comparison value is greater than the predefinable limit value, the data transmission between the communication subscriber of the first type and at least one of the plurality of communication subscribers of the second type is restricted or interrupted.

In this case, the load parameter represents a utilization of an existing capacity of one or more resources that are required for the purpose of data transmission. These resources are, in particular, the aforementioned resources, such as a hardware resource or a software resource. A hardware resource is, for example, computing power, storage or a number of communication channels. Examples of a software resource are services that serve the purpose of data transmission, such as telemetry services, file transfer services, or localization services.

The method in accordance with the invention renders it possible in a simple manner to adapt a data volume to be transmitted to a resource that is available in a limited manner.

One advantageous embodiment variant provides that, for the purpose of restricting or interrupting the data transmission in the case of a transmission of data that is regularly transmitted with a predefined frequency, this frequency is reduced. In this manner, it is possible to enable a simple reduction in the data volume flow.

One advantageous development provides that, for the purpose of restricting or interrupting the data transmission, at least one of the plurality of communication subscribers of the second type is selected in accordance with at least one selection criterion. This enables a specific selection of a communication subscriber of the second type, for which an at least partial communication silence can be provided.

One advantageous embodiment variant provides that a selection criterion of the first type is used as the at least one selection criterion, according to which at least one of the plurality of communication subscribers of the second type is selected in dependence upon a level of its contribution to the load parameter. In this manner, it is possible to achieve a cost-effective restriction of data traffic.

One advantageous embodiment provides that, in accordance with the selection criterion of the first type, at least one of the plurality of communication subscribers of the second type is selected, the contribution of said communication subscriber to the load parameter being the highest. In this manner, the method for controlling the data transmission can be optimized.

A further advantageous embodiment variant provides that the level of the contribution to the load parameter is measured on the basis of a use of a computing power, a storage space, a number of communication channels and/or a number of services that are claimed for the purpose of executing the data transmission by the said at least one communication subscriber of the second type for the purpose of the data transmission. In this manner, a flexibly adaptable control method can be realized.

One advantageous embodiment variant further provides that a relevance is allocated to each of the plurality of communication subscribers of the second type. Moreover, it is proposed that a selection criterion of the second type is used as the at least one selection criterion, according to which the at least one communication subscriber of the second type is selected in dependence upon the relevance that is allocated to this communication subscriber. When selecting a communication subscriber of the second type, a distinction can thus be made between important and less important communication subscribers. For example, the relevance of a communication subscriber of the second type can be based on a task that is allocated to it. Such a task can be, for example, a safety-related task, a rescue-related task, a transport task or an execution of a pause. Consequently, such relevance can be allocated in absolute terms to a communication subscriber of the second type or can be allocated in conjunction with a schedule and/or an event plan. Examples of a time and/or event plan are, for example, a timetable or a maintenance plan.

One advantageous embodiment provides that those communication subscribers of the second type to which a low relevance is allocated are preferably used or selected for the purpose of interrupting or restricting the data transmission.

One advantageous embodiment further provides that, in the event that data is to be transmitted by means of a communication subscriber of the second type, to which a high relevance is allocated, a data transmission of another communication subscriber of the second type, to which a low relevance is allocated, is restricted or interrupted. In this manner, it is possible to ensure that relevant data is transmitted in a preferred manner. In addition, this renders it possible to omit exceptions or extensive exceedances of the predefined limit value in the case of the transmission of relevant data.

Another advantageous embodiment variant proposes that a relevance is allocated to data that is to be transmitted. In this regard, a selection criterion of the third type is used as the at least one selection criterion, according to which the at least one communication subscriber of the second type is selected in dependence upon a relevance of the data that is to be transmitted by this communication subscriber. In this manner, a distinction can be made between important and less important data. Such a relevance relating to such data can be based, for example, on a type, an age, a size, a kind and/or a frequency of the intended transmission of the data or similar parameters of data. It is preferred that by means of the selection criterion of the third type, the communication subscriber of the second type is selected, by means of which a transmission of data of low relevance is provided.

In one advantageous embodiment, it is provided, in the case that data of high relevance is to be transmitted by one of the plurality of communication subscribers of the second type, a transmission of data of low relevance is restricted or interrupted in accordance with the selection criterion of the third type. In this manner, data to which a higher relevance has been allocated has priority over data to which a lower relevance has been allocated. Even with a high utilization of resources, data of high relevance can be transmitted. In this manner, a transmission of data of lower relevance can be deferred until a resource utilization allows a transmission of this data relevance.

In one advantageous development, it is provided that, by means of the communication subscriber of the first type, an instruction for the purpose of restricting or interrupting the data transmission is transmitted to the at least one communication subscriber of the second type that is selected in one of the aforementioned ways as soon as the comparison value is greater than the predefinable limit value. This renders it possible to arrange an at least partial communication silence. In particular, this can be called out simply and reliably by the communication subscriber of the first type as a central point to individual selected communication subscribers of the second type. Alternatively or additionally, it is conceivable here that, in the case of a transmission of files, the instruction is transmitted from at least one of the plurality of communication subscribers of the second type to the communication subscriber of the first type for the purpose of restricting or interrupting the data transmission.

A further advantageous development provides that the data transmission between the communication subscriber of the first type and at least one of the plurality of communication subscribers of the second type is restricted or interrupted until the comparison value is lower than the predefinable limit value. In this manner, existing resources can be protected against overload in a cost-effective manner. In addition, in this manner, overload-related failures or scaling due to an additional requirement of resources can be easily prevented.

One advantageous embodiment variant provides that a restriction or interruption of the said data transmission between the communication subscriber of the first type and at least one of the plurality of communication subscribers of the second type is at least in part cancelled as soon as the comparison value is lower than a threshold value. This is only always done to such an extent that the comparison value is lower than the aforementioned predefinable limit value. In this manner, the existing resources can be optimally used. The said threshold value is preferably always lower than the predefinable limit value or equal to the threshold value. It is conceivable that short-term exceedances of the limit value are tolerated. For example, in this manner, data of high relevance can be transmitted without making far-reaching interruptions or restrictions of other data or communication subscribers of the second type.

A further advantageous embodiment variant provides that in addition to a restriction or interruption of the data transmission as a result of which the comparison value is greater than the predefinable limit value, the data transmission between the communication subscriber of the first type and at least one of the plurality of communication subscribers of the second type is restricted or interrupted as a result of a predetermined event. Such an event may be, for example, a predetermined time, a schedule, a maintenance, an update, a predictable restart of one or more services, and/or another predictable activity associated with a time.

The method in accordance with the invention can be implemented by means of the system in accordance with the invention.

The system in accordance with the invention has a communication subscriber of the first type and a plurality of communication subscribers of the second type. In this case, the communication subscriber of the first type and the plurality of communication subscribers of the second type are connected to one another by means of a network. The communication subscriber of the first type and the plurality of communication subscribers of the second type are preferably connected to one another by means of the network for the purpose of data transmission. In addition, the system is configured so as to implement the method in accordance with the invention. In this manner, a dependable and reliable system can be provided.

One advantageous development provides that the communication subscriber of the first type is designed as a stationary communication subscriber. In addition, it is provided that the plurality of communication subscribers of the second type are each designed as mobile communication subscribers. The mobile communication subscribers are preferably in the form of vehicles. These vehicles are particularly preferably designed as rail-bound vehicles. In view of ever-increasing amounts of data to be transmitted from and to mobile communication subscribers, efficient and cost-effective control of the data transmission can be achieved in the manner described herein.

In addition, an advantageous development of the system provides that the plurality of relaying apparatuses of the communication subscriber of the second type are configured to transmit data between a local network and a mobile radio network. In this manner, effects of a poor reception of a relaying apparatus on a transmission of data can be compensated by a good reception of further relaying devices. Such a difference between a reception of a relaying apparatus and other rental apparatuses can arise, for example, through the use of different network providers.

The invention further provides a computer program. When executed, the computer program in accordance with the invention causes the system in accordance with the invention to implement the method in accordance with the invention.

In addition, the invention provides a computer-readable medium which has instructions on the basis of which the system in accordance with the invention is prompted to implement the method in accordance with the invention. The computer-readable medium can be, for example, a CD-ROM, a DVD, a USB or flash memory or a non-physical medium, such as a data stream and/or a data carrier signal.

The above-described characteristics, features and advantages of the invention and also the manner in which these are achieved are further explained in conjunction with the figures in the following description of the embodiments of the invention. Where appropriate, the same reference numerals are used in the figures for the same or mutually corresponding elements of the invention. The exemplary embodiment is used to explain the invention and does not limit the invention to the combinations of features disclosed therein, not even in relation to functional features. In addition, all features that are disclosed in the exemplary embodiment can be considered in isolation and can be suitably combined with the features of any desired claim.

In the drawings:

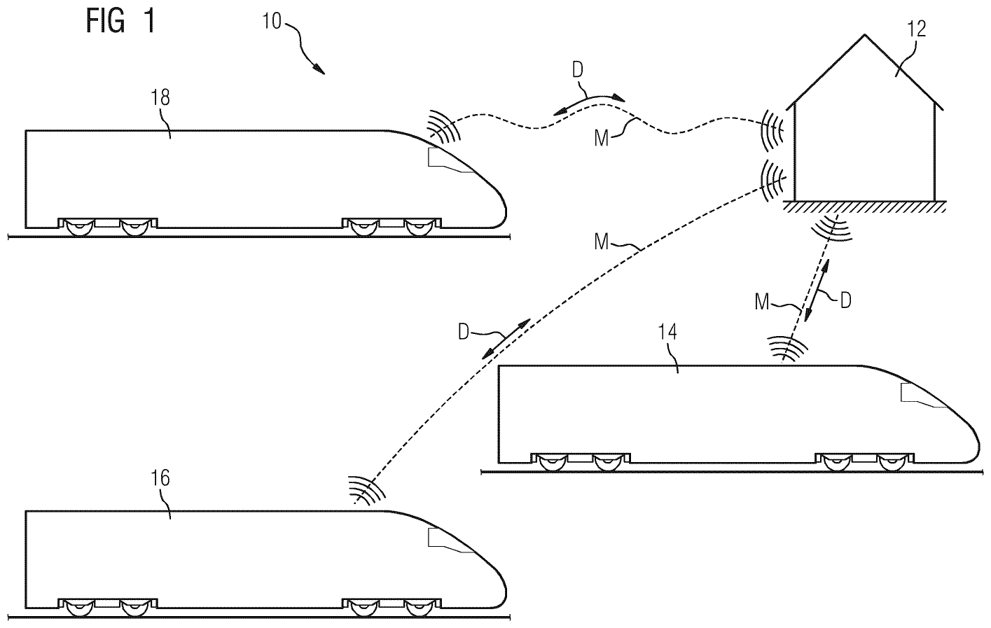

FIG. 1 shows an exemplary embodiment of a system in accordance with the invention;

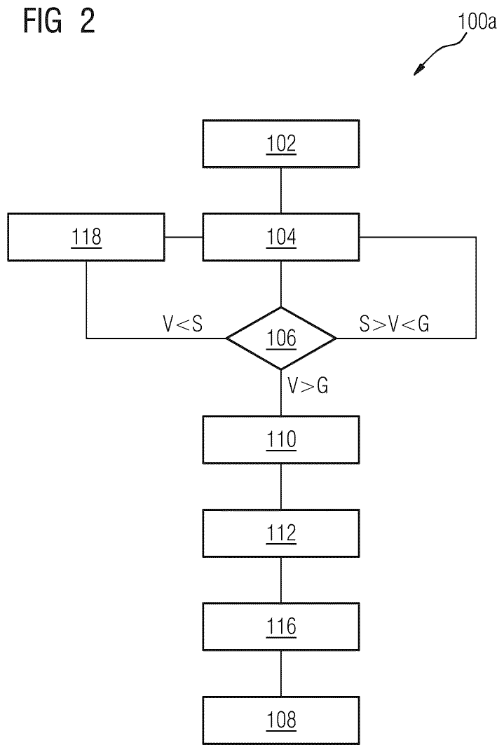

FIG. 2 shows a first example of a method in accordance with the invention for controlling a data transmission;

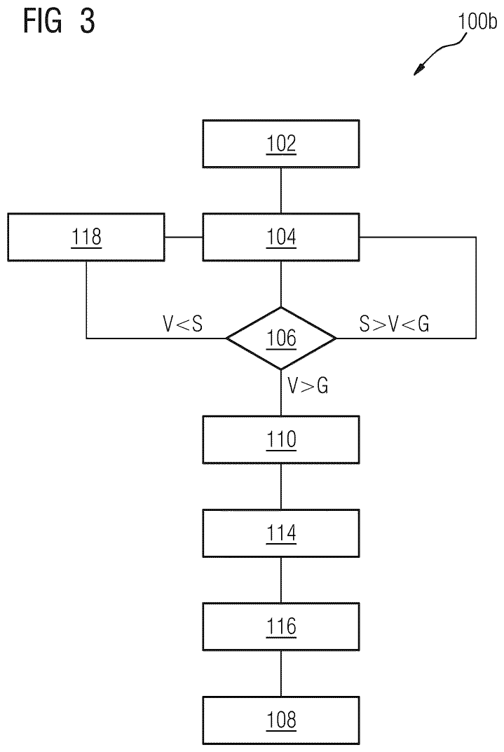

FIG. 3 shows a second example of the method in accordance with the invention for controlling a data transmission;

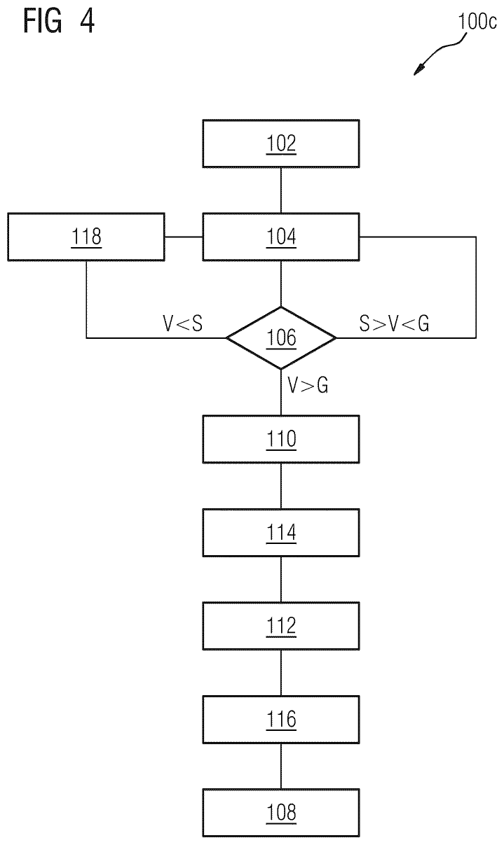

FIG. 4 shows a third example of the method in accordance with the invention for controlling a data transmission.

FIG. 1 illustrates an exemplary embodiment of a system 10. This system has, by way of example, a stationary communication subscriber 12 and three rail-bound vehicles 14, 16, 18 as mobile communication subscribers. For the purpose of a data transmission D, the stationary communication subscriber 12 and the three rail-bound vehicles 14, 16, 18 are connected to one another by means of a mobile radio network M. In addition, the system 10 is configured so as to control the aforementioned data transmission D between the stationary communication subscriber 12 and the three rail-bound vehicles 14, 16, 18 in the manner described in more detail below in conjunction with FIGS. 2 to 4.

FIG. 2 illustrates a first example of a method 100a for controlling the data transmission D between the stationary communication subscriber 12 and the three rail-bound vehicles 14, 16, 18. In this method 100a, a load parameter that is related to the data transmission D is detected 102. By way of example, this load parameter is a computing power that is required for the purpose of data transmission D. Alternatively or additionally, it is conceivable that a portion of a storage capacity that is occupied for the purpose of data transmission D or a number of communication channels that are required for this purpose are detected 102 as the load parameter. It is also conceivable that a number or a use of active services that are required for the purpose of the aforementioned data transmission D is detected 102 as a load parameter. Such services can be, for example, file transfer services, telemetry services or localization services. On the basis of the aforementioned computing power that is detected as a load parameter, a comparison value V is furthermore determined 104. In the present example, the comparison value V is determined 104 on the basis of averaging over a predetermined period of time. Alternatively, it is conceivable that the comparison value V is a sum or a sum per unit of time or a weighted average value per unit of time. After determining 104 the comparison value V, it is compared 106 with a predefinable limit value G. If this comparison 106 shows that the comparison value V is below the predetermined limit value G, the comparison value V is determined again 104 on the basis of the load parameter 102 that continues to be detected. If, on the other hand, the comparison value V is above the predefinable limit value G, at least one rail-bound vehicle 14, 16, 18 is selected 110 in accordance with a selection criterion for the purpose of restricting or interrupting 108 a data transmission D. In the present example of the method 100a, a selection criterion of the first type is used as the selection criterion, according to which at least one of the three rail-bound vehicles 14, 16, 18 is selected 110 in dependence upon a level of its contribution to the load parameter, that is to say to the computing power that is required for the purpose of the data transmission D. Consequently, on the basis of the selection criterion of the first type, that rail-bound vehicle 14, 16, 18 that occupies a largest proportion of an existing computing power capacity is selected 110. The level of the contribution to the load parameter is therefore measured 112 on the basis of an actual use of the computing power of the rail-bound vehicles 14, 16, 18 for the purpose of executing the data transmission D. In this manner, that rail-bound vehicle 14, 16, 18 that has a highest demand for the computing power in comparison with the other rail-bound vehicles 14, 16, 18 is first selected 110. Thereupon, for the purpose of restricting or interrupting 108 the data transmission D, an instruction to this effect is transmitted 116 to the rail-bound vehicle 14, 16, 18 that is selected in the aforementioned manner. In the present example of the method 100a, the data transmission D between the stationary communication subscriber 12 and the rail-bound vehicle 14, 16, 18 that is selected in the aforementioned manner is restricted or interrupted 108 until the comparison value V is lower than the predefinable limit value G. In addition, it is conceivable that, in addition to the aforementioned restriction or interruption 108 of the data transmission D as a result of which the predefinable limit value G is exceeded by the comparison value V, the data transmission D between the stationary communication subscriber 12 and at least one of the rail-bound vehicles 14, 16, 18 is restricted or interrupted 108 as a result of a predetermined event. Such an event may be, for example, a maintenance, a software update, or a predictable restart of one or more services or one or more rail-bound vehicles.

In addition, the method 100a provides that the restrictions or interruptions 108 of the data transmission D are at least partially cancelled 118 as soon as the comparison value V is lower than a predefined threshold value S. In the present example of the method 100a, the threshold value S is selected in such a manner that it is always lower than the limit value G. The cancellation of the restrictions or interruptions 118 is always performed to such an extent that the comparison value V remains lower than the aforementioned predefinable limit value G.

When performing an interruption 108 of the data transmission D, it is conceivable that an entire data transmission D between the stationary communication subscriber 12 and the selected rail-bound vehicle 14, 16, 18 is interrupted 108. Alternatively, the data transmission D to this selected rail-bound vehicle 14, 16, 18 can merely be restricted 108 by only partially interrupting the aforementioned data transmission D. For example, this limitation can extend to predetermined data, data types, files, or services. The service that has the greatest resource requirement with regard to computing power is preferably restricted.

FIG. 3 illustrates a second example of a method 100b for controlling a data transmission D. In particular, the data transmission D is the data transmission D that is described in connection with FIG. 1 and FIG. 2. The method 100b that is illustrated in FIG. 3 differs from the method 100a that is illustrated in FIG. 2 by virtue of the fact that, for the purpose of restricting or interrupting 108 the data transmission D, at least one of the rail-bound vehicles 14, 16, 18 is selected 110 in accordance with a selection criterion of the second type. For this purpose, a relevance is first allocated to each of the rail-bound vehicles 14, 16, 18. This relevance depends, for example, on the tasks of the rail-bound vehicle 14, 16, 18. Thus, a rail-bound vehicle 14, 16, 18 with rescue tasks can be given a higher priority than for those that only have freight transport tasks. In addition, the relevance in the event of a pause or maintenance of a rail-bound vehicle 14, 16, 18 can be adjusted accordingly. Consequently, it is conceivable that an absolute relevance is linked to an event-dependent relevance, such as a schedule or an event plan.

Alternatively or additionally, in the example of the method 100b that is illustrated in FIG. 3, a relevance is allocated 114 to data that is transmitted. In this case, a selection criterion of the third type is used for the purpose of restricting or interrupting 108 the data transmission D, according to which at least one of the rail-bound vehicles 14, 16, 18 is selected 110 in dependence upon a relevance of the data that is to be transmitted by this rail-bound vehicle 14, 16, 18. By way of example, such a relevance can be based on a type of data, such as media data or process data, an age, a size, a type or a frequency of an intended transmission of this data. In this case, it is proposed that, in the case that data of high relevance is to be transmitted by one of the rail-bound vehicles 14, 16, 18, a transmission of data of low relevance is restricted or interrupted 108.

This renders it possible to easily give priority to data of high relevance. In this case, it is conceivable that short-term exceedances of the limit value G are tolerated, in order to transmit data of a high relevance, for example, without having to make far-reaching interruptions or restrictions 108 for a very short period of time.

FIG. 4 illustrates a third example of a method 100c for controlling a data transmission D. In particular, the data transmission is the data transmission D that is described in connection with FIG. 2 and FIG. 3. The method 100c that is illustrated in FIG. 4 differs from the methods 100a, 100b that are illustrated in FIG. 2 and FIG. 3 by virtue of the fact that, the method 100c for the purpose of restricting or interrupting 108 the data transmission D, at least one of the rail-bound vehicles 14, 16, 18 is selected 100c by means of a combination of the selection criterion of the first type, which is described in connection with FIG. 2, and also the selection criterion of the third type, which is described in connection with FIG. 3. By way of example, in the method 100c, in the case that the comparison value V exceeds the predefinable limit value G, that rail-bound vehicle 14, 16, 18 that has been assigned the lowest relevance is selected first 110. Thereupon, from the data that is to be transmitted by the rail-bound vehicle 14, 16, 18 that is selected in the aforementioned manner, the data or data groups that have a greatest contribution to the load parameter are selected 110 in accordance with the selection criterion of the first type. In this case, the aforementioned selection criterion of the first type is the selection criterion already described in connection with FIG. 1, in which the aforementioned contribution is measured 112, by way of example, in the manner already described in connection with FIG. 1.

In addition, further advantageous embodiment variants of a method for controlling the data transmission D are conceivable, in which the selection criteria of the first, second and/or third type are combined in a suitable manner.

Although the invention has been further illustrated and described in detail by the above embodiments, the invention is not limited in this regard by the disclosed examples and other variations can be derived therefrom by the person skilled in the art without departing the scope of the invention.

1-15. (canceled)

16. A method for controlling a data transmission between a communication subscriber of a first type and a plurality of communication subscribers of a second type, the method comprising:
detecting at least one load parameter that is related to the data transmission;
determining a comparison value on a basis of the at least one load parameter;
comparing the comparison value with a predefinable limit value;
restricting or interrupting the data transmission between the communication subscriber of the first type and at least one of the plurality of communication subscribers of the second type when the comparison value is greater than the predefinable limit value.

17. The method according to claim 16, wherein the step of restricting or interrupting the data transmission comprises selecting at least one of the plurality of communication subscribers of the second type from the plurality of communication subscribers of the second type in accordance with at least one selection criterion.

18. The method according to claim 17, which comprises using a selection criterion of a first type as the at least one selection criterion, according to which the at least one of the plurality of communication subscribers of the second type is selected in dependence upon a level of a contribution of the at least one subscriber to the load parameter.

19. The method according to claim 18, which comprises measuring the level of the contribution to the load parameter on a basis of at least one parameter selected from the group consisting of a computing power, a storage space, a number of communication channels, and a number of services that are claimed for executing the data transmission by the at least one communication subscriber of the second type.

20. The method according to claim 17, which comprises:
allocating a relevance to the communication subscribers of the second type; and
using a selection criterion of a second type as the at least one selection criterion, according to which the at least one communication subscriber of the second type is selected in dependence upon the relevance allocated to the respective communication subscriber.

21. The method according to claim 17, which comprises:
allocating a relevance to data that is to be transmitted; and
using a selection criterion of a third type as the at least one selection criterion, according to which the at least one communication subscriber of the second type is selected in dependence upon the relevance of the data to be transmitted by the respective communication subscriber.

22. The method according to claim 21, which comprises, when data of high relevance is to be transmitted by one of the plurality of communication subscribers of the second type, restricting or interrupting a transmission of data of low relevance in accordance with the selection criterion of the third type.

23. The method according to claim 16, which comprises transmitting, by the communication subscriber of the first type an instruction for restricting or interrupting the data transmission to a respectively selected at least one communication subscriber of the second type as soon as the comparison value is greater than the predefinable limit value.

24. The method according to claim 16, which comprises restricting or interrupting the data transmission between the communication subscriber of the first type and at least one of the plurality of communication subscribers of the second type until the comparison value is lower than the predefinable limit value.

25. The method according to claim 24, which comprises at least partially canceling a restriction or interruption of the data transmission between the communication subscriber of the first type and at least one of the plurality of communication subscribers of the second type as soon as the comparison value is lower than a threshold value, with the proviso that the comparison value is lower than the said predefinable limit value.

26. The method according to claim 24, which comprises, in addition to restricting or interrupting the data transmission when the comparison value exceeds the predefinable limit value, restricting or interrupting the data transmission between the communication subscriber of the first type and at least one of the plurality of communication subscribers of the second type due to a predetermined event.

27. A communications system, comprising:
a communication subscriber of a first type and a plurality of communication subscribers of a second type connected to one another by way of a network;
said communication subscriber of the first type and said plurality of communication subscribers of the second type being configured to implement the method according to claim 16.

28. The system according to claim 27, wherein said communication subscriber of the first type is configured as a stationary communication subscriber, and each of said plurality of communication subscribers of the second type is a mobile communication subscriber.

29. The system according to claim 28, wherein said communication subscribers of the second type are vehicles.

30. The system according to claim 28, wherein said communication subscribers of the second type are rail-bound vehicles.

31. A non-transitory computer program which, when executed, causes the system (10) having a communication subscriber of a first type and a plurality of communication subscribers of a second type that are connected to one another by way of a network to implement the method according to claim 16.

32. A non-transitory computer readable medium, comprising instructions that cause a system having a communication subscriber of a first type and a plurality of communication subscribers of a second type that are connected to one another by way of a network to implement the method according to claim 16.
